(19) United States
(12) Patent Application Publication
(10) Pub. No.: US 2007/0043309 A1
(43) Pub. Date: Feb. 22, 2007

(54) Device for stimulating a skeleton in a body

(76) Inventor: Juergen Luetke-Wenning, Uissigheim (DE)

Correspondence Address: STRIKER, STRIKER & STENBY, 103 EAST NECK ROAD, HUNTINGTON, NY, 11743, US

(21) Appl. No.: 11/505,015

(22) Filed: Aug. 16, 2006

(30) Foreign Application Priority Data
Aug. 17, 2005 (DE) 20 2005 012 960.7

(51) Int. Cl. A61H 1/00

(52) U.S. Cl. 601/86; 601/87; 601/90; 601/93

(57) ABSTRACT

A device for stimulating a skeleton in a body has a vibrating platform which is vibratably supported in an at least approximately horizontal plane, and all the points of the platform describe a closed orbital path.

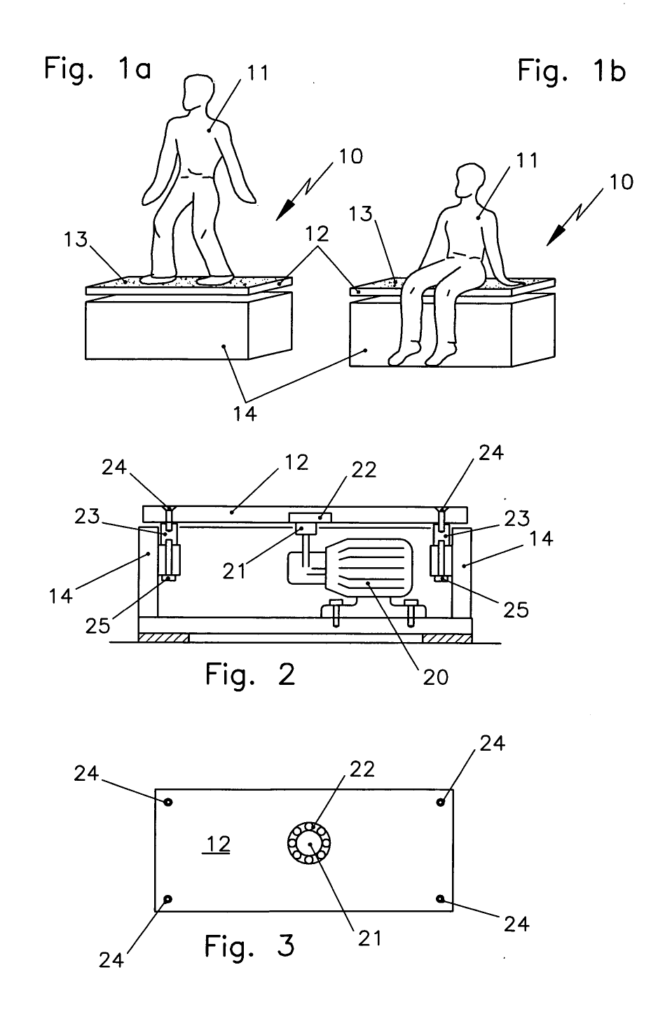

### CROSS-REFERENCE TO A RELATED APPLIACTION

The invention described and claimed hereinbelow is also described in German Patent Application DE 20 2005 012 960.7 filed on Aug. 17, 2005. This German Patent Application, whose subject matter is incorporated here by reference, provides the basis for a claim of priority of invention under 35 U.S.C. 119(a)-(d).

### BACKGROUND OF THE INVENTION

The invention relates to a device for stimulating a skeleton in a body, in particular to the device having a vibrating platform.

From the prior art, so-called vibration training devices are generally known that are used in the field of physiotherapy in order to train the musculature of a person. The musculature is stimulated by the vibrations, so that the muscles increasingly tighten or relax. However, it is hardly known to use such vibration training devices to stimulate the skeleton in a body.

### SUMMARY OF THE INVENTION

Accordingly, it is an object of the present invention to provide a device which is operative for stimulating a skeleton in a body.

In keeping with these objects and with others which will become apparent hereinafter, one feature of the present invention resides, briefly stated, in a device for stimulating a skeleton in a body, the device having a vibrating platform which is supported vibratably in an at least horizontal plane, wherein all the points of the platform describe a closed orbital path.

In this way, forces are generated that act on the skeleton and thus prevent destruction of individual bones and even reinforce a buildup of bone substance and cartilage substance. Consequently, the device can impede the progression of osteoporosis and even reverse it.

With the device, in the case of arthritis and rheumatic conditions, pain can be lessened, metabolism in the bones can be stimulated, and the bone density can be increased. The metabolism in the joints is also improved, and as a result, articular cartilage and synovial fluid are built up. The locomotor system can thus regenerate faster, for instance after operations or in the case of age-dictated wear. The effect on the body and the skeleton that is generated by the device is in accordance with the principles of Tai Chi and also results in relaxation of the muscles.

The above effects are especially pronounced if in accordance with the present invention the closed orbital path is a circle or an ellipse.

So that all the points of the platform are able to describe the closed orbital path, the platform in accordance with the present invention may be driven with a drive that has an eccentric.

Especially in physiotherapeutic treatment of the locomotor system, it can be useful if the eccentricity can be set to certain values. It is thus possible for instance, for worn joints or if the bone substance is decreasing, to set the eccentricity to particular preferred values. For generating the effects described, it is advantageous if the eccentricity is in a range between 1.5 mm and 1.7 mm. An eccentricity of 1.6 mm is usually preferred in practice.

To enable optimally generating the effects described, the orbital direction of the closed orbital path in accordance with the present invention can be counter to the rotation of the Earth. It is consequently advantageous if the closed orbital path is counterclockwise in the northern hemisphere and clockwise in the southern hemisphere.

Expediently, the drive in accordance with the present invention can have an electric motor, which may be connected to a crank and thus generates the eccentricity.

Depending on the particular treatment being performed, the rotary speed of the drive can be settable to a defined value. To generate the effects described an rpm range of between 600 and 850 rpm has proved especially effective. A rotary speed of 750 rpm is usually preferred in practice.

To lighten the work of the physiotherapist and/or a person who is to be treated, the device in accordance with the present invention may have a time switch clock for automatically switching off the drive.

The device can be connected to a household electrical system. In addition or alternatively, however, it is also possible to equip the device with a rechargeable battery, so that it can also be operated independently of the household electrical system.

The platform may be secured in the region of its corners to a boxlike substructure by elastic connecting elements. The elastic connecting elements may preferably be made from rubber. Besides securing the platform to the substructure, they also enable a required freedom of motion of the platform, for its vibrational motions, relative to the substructure.

To enable transmitting the rotary motion of the drive to the platform with as little friction as possible, the device can be equipped with a roller bearing, which can preferably be a ball bearing or a roller bearing. It is advantageously located on the underside of the platform. To generate the vibrating motion, it is expedient to locate the roller bearing outside the center point of the platform.

Alternatively for generating the vibrational motion, a roller bearing located at the center of the platform can be used, in the case of which an inner bearing race is located eccentrically to one outer bearing race. The roller bearing may also be a pendulum roller bearing or a pendulum ball bearing. If the person stands off-center on the platform, as typically happens, such pendulum roller bearings or pendulum ball bearings have a longer service life.

The substructure is sturdy and attractive in terms of design if it is constructed from multilayer wooden slats. For the same reason, the platform can also have a multilayer wooden slat. The wooden slats may be made from beechwood or imitation beechwood. Alternatively, the substructure and/or the platform may be made from plastic.

So that the person to be treated has a secure hold on the device, a slip-proof mat may be located on the platform in accordance with the present invention.

The device can have a guardrail, which the person can hold onto firmly during the treatment. The guardrail may either be set up next to the device or secured to the substructure or to the platform. In practice, a bar-like guardrail that can be set up next to the device has proved to be especially good.

The novel features which are not considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

1. A device for stimulating a skeleton in a body, comprising a vibrating platform which is supported vibratingly in an at least horizontal plane, and all points of said platform describe a closed orbital path; and further comprising means for driving said vibrating platform.

2. A device as defined in claim 1, wherein said means for driving said vibrating platform is configured so that said platform describes the closed orbital path selected from the group consisting of a circular path and an elliptic path.

3. A device as defined in claim 1, wherein said means for driving said vibrating platform include a drive that has an eccentric element.

4. A device as defined in claim 3, wherein said means for driving said vibrating platform is configured so that an eccentricity is settable to defined values.

5. A device as defined in claim 1, wherein said means for driving said vibrating platform is configured so that an orbital direction of said closed orbital path is counter to a rotation of Earth.

6. A device as defined in claim 1, wherein said means for driving said vibrating platform include a drive which has an electric motor.

7. A device as defined in claim 6, wherein said drive is configured so that a rotary speed of said drive is settable to a defined value.

8. A device as defined in claim 1, wherein said means for driving said vibrating platform include a drive; and further comprising a time switch clock for automatically switching off said drive.

9. A device as defined in claim 1; and further comprising a connection to an element selected from the group consisting of a household electrical system, a rechargeable battery, and both.

10. A device as defined in claim 1; and further comprising a boxlike substructure, and elastic connecting elements, by which said platform is secured in a region of its corners to said boxlike substructure.

11. A device as defined in claim 1; and further comprising a roller bearing which receives a motion from a drive of said vibrating platform.

12. A device as defined in claim 10, wherein at least one of elements selected from the group consisting of said platform, said substructure, and both is composed of multilayer wooden slats.

13. A device as defined in claim 1; and further comprising a slip-proof mat provided on said platform for maintaining a stable position of a user.

14. A device as defined in claim 1; and further comprising a guide rail holdable by a user.
